(19) United States
(12) Patent Application Publication
(10) Pub. No.: US 2026/0330957 A1
(43) Pub. Date: Oct. 22, 2026

(54) SYSTEM AND METHOD FOR RAPID RESPONSE TO A FALL RISK OR EVENT

(71) Applicant: MYRAINA, INC., West Chester, PA (US)

(72) Inventors: Albert Fitzgerald Elcock, West Chester, PA (US); Richard Moore, Harleysville, PA (US); Prema Venkatesulu, Langhorne, PA (US)

(21) Appl. No.: 19/653,518

(22) Filed: Apr. 21, 2026

Related U.S. Application Data
(60) Provisional application No. 63/792,559, filed on Apr. 22, 2025.

(51) Int. Cl. G08B 25/00; G08B 21/04

(52) U.S. Cl. CPC G08B 25/005; G08B 21/043; G08B 21/0476; G08B 25/001

(57) ABSTRACT

A system for response to a detected fall or fall risk is described. Monitoring devices include at least a first monitoring device having a first camera and a second monitoring device having a second camera. Mobile devices include at least a first mobile device and a second mobile device. A controller is communicatively coupled to the monitoring devices and the mobile devices. The first monitoring device is configured to send biomechanical information to the controller captured by the first camera. The controller is configured to detect a fall or a fall risk of a subject based on the biomechanical information received from the first monitoring device. A first alert signal and a second alert signal are determined based on the proximity comparison. A method for response to a detected fall or fall risk is also described.

### CROSS-REFERENCE TO RELATED APPLICATIONS

This application claims priority to U.S. provisional application No. 63/792,559 filed on Apr. 22, 2025 incorporated herein by reference in its entirety.

### BACKGROUND OF THE INVENTION

Every year in the US alone, millions of older people (65 and over) fall. In fact, more than one out of four older people fall each year. Falling once doubles your chances of falling again. In senior living communities, more than 56% of residents fall each year and the average time to discover the fallen individual is greater than 45 minutes nationwide. This duration increases the risk of adverse health issues as it has also been documented that 50% of those who are discovered more than 60 minutes after a fall die within 6 months.

Senior living communities and rehab facilities pose a unique challenge in that the ratio of staffing to patients limits the ability to monitor patients all the time. Moreover, not every staff member is qualified to address a patient's needs who has fallen. There are times when more than one staff member will need to be notified so that each can perform their specific duties. For example, one person may be needed to move the fallen individual and the other may be needed to administer health related diagnostics.

Thus, there is a need in the art for providing a way to detect a fall risk or that a patient has fallen and dispatching notifications to the appropriate individual(s) who are closest to where the accident occurred, thus increasing response times, increasing effectiveness of the initial response, and decreasing the occurrence of over-dispatching resources that are not ultimately needed or helpful.

### SUMMARY OF THE INVENTION

In one embodiment, a system for response to a detected fall or fall risk includes a plurality of monitoring devices including at least a first monitoring device having a first camera and a second monitoring device having a second camera; a plurality of mobile devices including at least a first mobile device and a second mobile device; and a controller communicatively coupled to the plurality of monitoring devices and the plurality of mobile devices; wherein the first monitoring device is configured to send biomechanical information to the controller captured by the first camera; the controller is configured to detect a fall or a fall risk of a subject based on the biomechanical information received from the first monitoring device; and wherein the controller is configured to: send a first alert signal to the first mobile device based on a proximity comparison of first caregiver location data received from the first mobile device, second caregiver location data received from the second mobile device, and preset first location data associated with the first monitoring device, and send a second alert signal to the second mobile device based on the proximity comparison, wherein the first alert signal and the second alert signal are determined based on the proximity comparison. In one embodiment, the first alert signal and the second alert signal are different based on the proximity comparison. In one embodiment, the first alert signal is modified based on a capabilities comparison of a first caregiver profile associated with the first mobile device and a second caregiver profile associated with the second mobile device. In one embodiment, the second alert signal is modified based on a capabilities comparison of a first caregiver profile associated with the first mobile device and a second caregiver profile associated with the second mobile device. In one embodiment, the controller is configured to send a third alert signal to a third mobile device based on the proximity comparison further including third caregiver location data received from a third mobile device, wherein the third alert signal is different from the first alert signal and the second alert signal. In one embodiment, the controller is configured to send an escalation signal to the first and second mobile devices based on reaching a threshold time without a video signal captured by the first camera detecting arrival of a caretaker. In one embodiment, the controller is configured to send first and second escalation notifications to the first and second mobile devices based on an updated proximity comparison of updated first caregiver location data and updated second caregiver location data. In one embodiment, controller is configured to detect a de-escalation signal based on a biomechanical information captured by the first camera detecting arrival of a caretaker. In one embodiment, the controller is configured to send first and second de-escalation notifications to the first and second mobile devices based on an updated proximity comparison of updated first caregiver location data and updated second caregiver location data. In one embodiment, the controller is configured to detect a de-escalation signal based on a biomechanical information captured by the first camera detecting an unfelled position of the subject. In one embodiment, the proximity comparison comprises at least one of a distance proximity comparison and a time of arrival proximity comparison.

In one embodiment, a method for response to a detected fall or fall risk includes the steps of detecting a fall or fall risk of a subject based on biomechanical information captured by a first camera of a first monitoring device; sending a first alert signal to a first mobile device based on a proximity comparison of first caregiver location data received from the first mobile device, second caregiver location data received from a second mobile device, and preset first location data associated with the first monitoring device; sending a second alert signal to the second mobile device based on the proximity comparison, wherein the first alert signal and the second alert signal are determined based on the proximity comparison. In one embodiment, the first alert signal and the second alert signal are different based on the proximity comparison. In one embodiment, the first alert signal is modified based on a capabilities comparison of a first caregiver profile associated with the first mobile device and a second caregiver profile associated with the second mobile device. In one embodiment, the second alert signal is modified based on a capabilities comparison of a first caregiver profile associated with the first mobile device and a second caregiver profile associated with the second mobile device. In one embodiment, the method includes the step of sending a third alert signal to a third mobile device based on the proximity comparison further including third caregiver location data received from a third mobile device, wherein the third alert signal is different from the first alert signal and the second alert signal. In one embodiment, the method includes the step of sending an escalation signal based on reaching a threshold time without a video signal captured by the first camera detecting arrival of a caretaker. In one embodiment, the method includes the step of sending first and second escalation notifications to the first and second mobile devices based on an updated proximity comparison of updated first caregiver location data and updated second caregiver location data. In one embodiment, the method includes the step of the controller detecting a de-escalation signal based on a biomechanical information captured by the first camera detecting arrival of a caretaker. In one embodiment, the method includes the step of sending first and second de-escalation notifications to the first and second mobile devices based on an updated proximity comparison of updated first caregiver location data and updated second caregiver location data. In one embodiment, the method includes the step of sending a de-escalation signal based on a biomechanical information captured by the first camera being sent to the controller, and which the controller detects an unfelled position of the subject. In one embodiment, the proximity comparison comprises at least one of a distance proximity comparison and a time of arrival proximity comparison.

In one embodiment, a system for response to a detected fall or fall risk includes a plurality of monitoring devices including at least a first monitoring device having a first camera and a second monitoring device having a second camera; a plurality of locator devices including at least a first locator device and a second locator device; and a controller communicatively coupled to the plurality of monitoring devices and the plurality of locator devices; wherein the first monitoring device is configured to send biomechanical information to the controller captured by the first camera; the controller is configured to detect a fall or a fall risk of a subject based on the biomechanical information received from the first monitoring device; and wherein the controller is configured to: send a first alert signal to the first alert device based on a proximity comparison of first caregiver location data received from the first locator device, second caregiver location data received from the second locator device, and preset first location data associated with the first monitoring device, and send a second alert signal to the second alert device based on the proximity comparison, wherein the first alert signal and the second alert signal are determined based on the proximity comparison. In one embodiment, first caregiver location data received from the first locator device is determined based on at least one of image recognition or signal recognition associated with the first caregiver. In one embodiment, the first caregiver location data received from the first locator device is determined based on at least one is at least one of facial recognition, badge recognition and RF signal recognition.

In one embodiment, a method for response to a detected fall or fall risk includes the steps of detecting a fall or fall risk of a subject based on biomechanical information captured by a first camera of a first monitoring device; sending a first alert signal to a first locator device based on a proximity comparison of first caregiver location data received from the first locator device, second caregiver location data received from a locator mobile device, and preset first location data associated with the first monitoring device; sending a second alert signal to the second alert device based on the proximity comparison, wherein the first alert signal and the second alert signal are determined based on the proximity comparison. In one embodiment, first caregiver location data received from the first locator device is determined based on at least one of image recognition or signal recognition associated with the first caregiver. In one embodiment, the first caregiver location data received from the first locator device is determined based on at least one is at least one of facial recognition, badge recognition and RF signal recognition.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A is a diagram of an environment for implementing a system for responding to a detected fall or fall risk according to one embodiment; and FIG. 1B is a system diagram of a system for responding to a detected fall or fall risk according to one embodiment.

FIG. 2 is a flow chart of a method for responding to a detected fall or fall risk according to one embodiment.

FIG. 3 is a diagram of a computing environment in which a rapid response system may be implemented according to one embodiment.

### DETAILED DESCRIPTION OF THE INVENTION

It is to be understood that the figures and descriptions of the present invention have been simplified to illustrate elements that are relevant for a more clear comprehension of the present invention, while eliminating, for the purpose of clarity, many other elements found in systems and methods for responding to a detected fall or fall risk. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein is a system and method for responding to a detected fall or fall risk.

Embodiments of the system include detecting where a monitored patient has fallen or are at risk for a fall within the premises, including the steps of identifying the individual and determining that the individual has fallen or is at risk for a fall. Embodiments described herein that refer to detecting a fall may also be applied when a fall risk is detected. Similarly, where a fallen patient is described, the embodiment may also apply to a patient with a detected fall risk. For example, the system may determine the fallen individual's location within the premises via a location of a diagnostic health monitoring device's preconfigured information. A diagnostic monitor portal allows entry of configuration information associated with the system. A user (for example an administrator, installer, etc.) enters the location of the diagnostic health monitoring device location within the premises. The system also determines the location of caregivers within the premises or outside the premises. The system detects caregivers' proximity to where a monitored patient has fallen within or outside the premises, and which are closest to the incident. The system sends notifications of the fallen monitored patient to a configurable range of people in the care network, however, the notification may be presented in a different manner to the caregivers who are closest to where the fallen monitored patient is within the premises.

Embodiments of the system continue monitoring the fallen or fall risk patient after notifications have been sent and detect that caregivers have responded to the fallen or fall-risk patient within the premises. Renotifications can be sent as appropriate to the caregivers. Once a response has been detected, updated notifications are sent to caregivers and facility personnel. Additional people may be notified or renotified if no response is observed in a timely manner—this includes detecting the presence of another person in proximity to the person being monitored. The range of people receiving notifications may also be widened in subsequent notifications if no response is observed in a timely manner. Notifications are sent to facility administration staff to alert them of incident and status updates on response to incident.

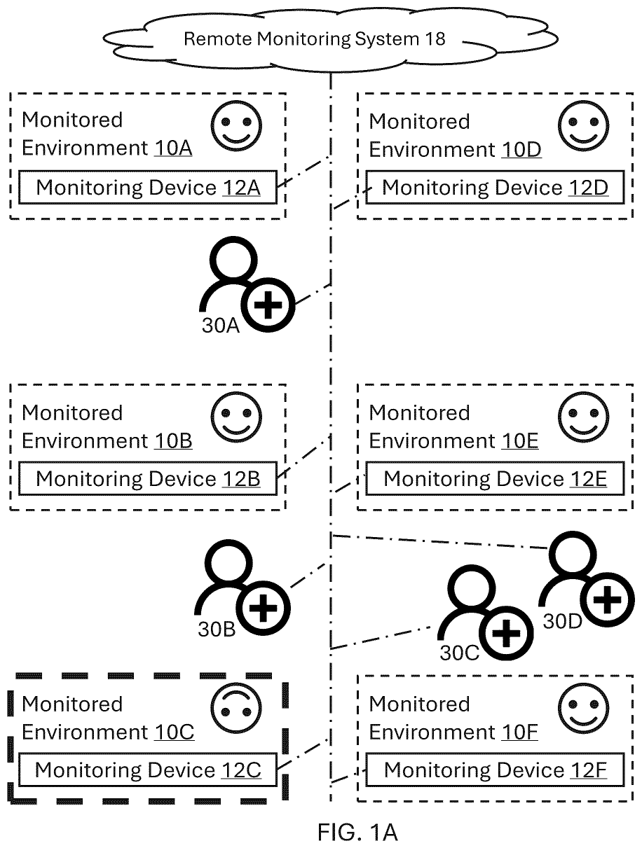

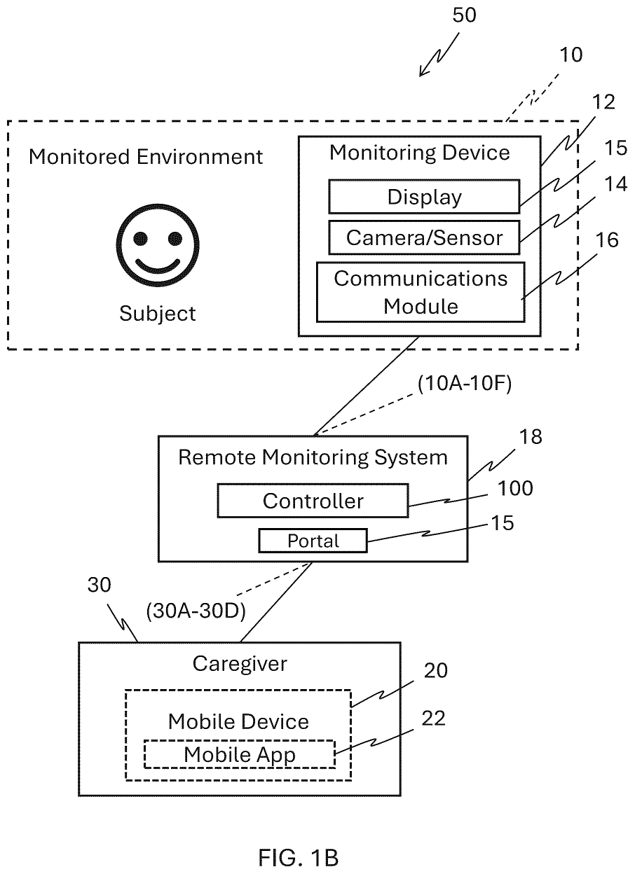

With reference now to FIG. 1A, an environment is shown that includes various patient monitored environments 10A, 10B, 10C, 10D, 10E and 10F. The patient monitored environments may for example be different areas in a single building such as different patient rooms, or on a larger scale different houses or apartments for patients being monitored at home within a certain geographical region. Similarly, the caregivers 30A, 30B, 30C and 30D may represent caregiver locations within a single building such as an elderly care facility, or caregiver locations in a larger scale geographical region such as their current working or off-duty location. Patient monitored environments and caregiver locations can include any combination of small- or large-scale environments, or more generally anywhere the patient resides, whether temporarily or permanently. Further, the number of monitored environments may be for example as few as two monitored environments or several hundred or more. Each patient monitored environment 10A, 10B, 10C, 10D, 10E and 10F includes a monitoring device 12A, 12B, 12C, 12D, 12E and 12F placed in the corresponding patient monitored environment. Certain monitored environments for a single patient may have two or more monitoring devices, for example when needed for multiple fields of view (e.g. different rooms separated by walls or other field of view obstructions, inside vs. outside areas, etc.). With additional reference to FIG. 1B, each monitoring device 12 includes a camera 14 and/or sensor for monitoring the patient. The monitored environment 10 may for example be an entire room, a series of rooms, a partial area of a room, and indoor and/or outdoor area, or a field of view for the camera 14 and/er sensors. Each monitoring device 12 can include one or more cameras 14 and sensors for detecting for example when an elderly person is present, not present, awake, asleep, moving, not moving, making sounds, not making sounds, or in a particular positional state such as in an upright or felled position. The monitoring system 50 can include a communications module 16 for communicating the monitoring data with a controller 100 that communicates with a remote monitoring system 18. A portal 15 provides user access to the remote monitoring system 18. Functionally, a controller 100 may reside for example in a cloud, a computer within or outside the environment, a mobile device or at a monitoring device, so long as it is communicatively coupled to each monitoring device 12. Embodiments of each monitoring device 12 may include an integrated LCD display 25 which may include features for improving the privacy of the patient being monitored and reducing the feeling of being monitored. Each monitoring device 12 in one embodiment may include a processor (CPU), wireless interfaces, dynamic memory and one or more AI accelerators. A permanent storage, peripherals and learn mode button provide optional feature additions for extensibility.

In one embodiment, a controller 100 and remote monitoring system 18 can communicate with each other and the monitoring device 12 via wired and/or wireless connections and communication modules. The controller 100 can for example be one or a series of computing devices such as a handheld mobile device or computer that communicate with the monitoring device 12 and remote monitoring system 18. Multiple devices can be used, for example by elderly users in the monitored environment 10 and by medical professionals or caretakers in the environment or from a remote location. The remote monitoring system 18 communicates with caregiver mobile devices 20 such as smart phone or tablets running a mobile app 22 for receiving important system communications, alerts and notifications, for providing location data such as a GPS location, and for providing caregiver feedback.

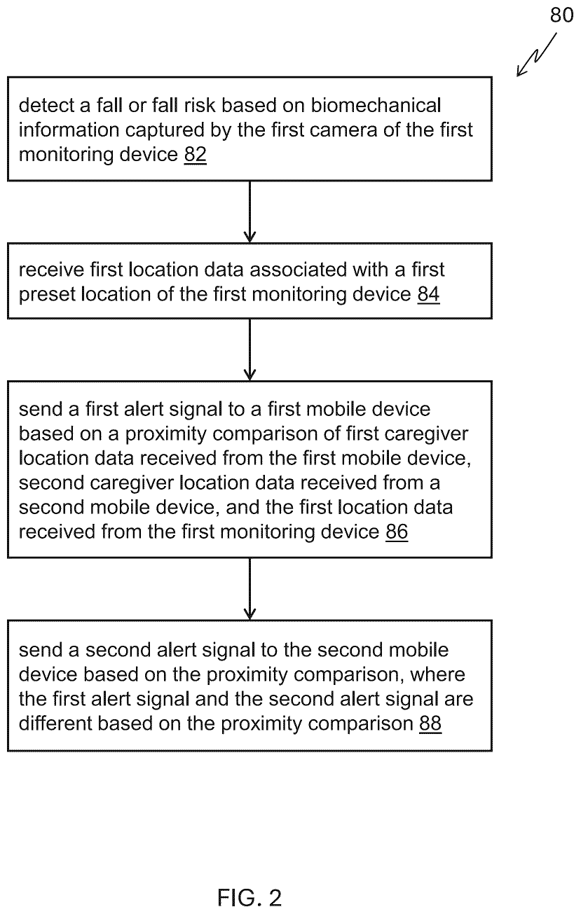

Thus for example, with continued reference to FIGS. 1A and 1B and additional reference to the flow chart in FIG. 2, an embodiment of steps for a method 80 of detecting an incident, sending out notifications and detection of a timely response to the incident is described according to one embodiment. First, the remote monitoring system detects a fall or fall risk based on biomechanical information captured by the first camera of the first monitoring device 82. Detecting a fall or fall risk may utilize embodiments of fall or fall risk detection systems and methods described in U.S. Ser. No. 18/673,850 filed May 24, 2024 by Elcock et al., U.S. Ser. No. 18/673,882 filed May 24, 2024 by Elcock et al., and U.S. Ser. No. 18/673,924 filed May 24, 2024 by Elcock et al., all of which are herein incorporated by reference. Further, upon fall or fall risk detection, safety lighting systems and methods can be triggered according to embodiments described in U.S. Ser. No. 18/981,897 filed Dec. 16, 2024 by Elcock et al, herein incorporated by reference. Next, the remote monitoring system receives first location data associated with a first preset location of the first monitoring device 84. Thus when the remote monitoring system detects a fall or fall risk based on biomechanical information from a monitoring device, it immediately sends a notification to caregivers. The remote monitoring system has a list of caregivers and once the incident is detected, the remote monitoring system then determines which caregivers are in closest proximity to the incident. In one embodiment, closest proximity is determined to be the caregiver the shortest distance away from the fallen individual, and that specific caregiver gets specific notifications to respond as quickly as possible. Accordingly, the remote monitoring system needs to determine proximity of multiple caregivers before selecting a caregiver in closest proximity. Thus, the remote monitoring system sends a first alert signal to a first mobile device based on a proximity comparison of first caregiver location data received from the first mobile device, second caregiver location data received from a second mobile device, and the first location data received from the first monitoring device 86. The number of devices that can be notified based on proximity is not limited and can for example be configurable based on a proximity range.

With reference back to FIG. 1A for example, caregivers 30A, 30B, 30C and 30D are caregivers that are each communicatively connected to the remote monitoring system 18 via their mobile devices and each have a different proximity to the fallen patient in monitored environment 10C. As noted above, embodiments that discuss a fallen patient may also be applied to patients with a detected fall risk. When monitoring device 12C communicates to the remote monitoring system 18 that the patient is fallen, the system immediately retrieves location data from each caregiver 30A, 30B, 30C and 30D. In this example, caregiver 30B is determined to have the closest proximity based on a distance proximity determination so in one embodiment caregiver 30B is selected as the first responder and given specialized messaging based on their position as first responder role which is different from the messaging provided to caregivers 30A, 30C and 30D. Closest proximity may also be determined by time of arrival proximity. For example, if caregiver 30C is determined to have a faster time of arrival proximity to the fallen patient, even though caregiver 30B is determined to be a closer distance from the fallen patient, caregiver 30C will be determined as having closer proximity and will be selected as the first responder. In that case, caregiver 30C will receive the most heightened level of messaging from the system. Criteria such as traffic conditions, transportation availability, weather conditions and others may be evaluated in real time best determine time of arrival proximity. Further, factors such as ability of the caretakers may be accounted for, such as ability to lift patients over the identified patient's weight, or ability to provide needs preset in the system associated with the identified patient, such as physical, pharmaceutical or mental health needs. Thus patient needs and ability of caretakers to meet these needs may ultimately determine the first responder position, eclipsing closest distance or time of arrival proximity. System administrators can decide circumstances when a caretaker with a lower-ranked distance or time of arrival proximity may ultimately get bumped-up to first responder status to meet critical needs of the fallen patient. Further, a subset of caretakers may be assigned first responder status as a group (e.g. a pair of first responders) if for example if critical patient needs are split between the abilities of different caretakers, ensuring that critical time sensitive needs are met.

Additionally, certain embodiments may not necessarily rely on mobile devices for determining caregiver proximity or alerting caregivers. For example, in the setting of a medical or elder care facility, cameras and monitoring devices located throughout the facility may be utilized to locate and alert caregivers. Locator devices such as cameras or other sensors may rely on image recognition or signal recognition associated with individual caregiver, such as facial recognition, badge recognition and RF signal recognition and other recognition modalities known in the art. Further, the locator devices can communicate with the remote monitoring system and alert devices (e.g. wall mounted units throughout the facility and the like) for alerting caregivers based on their location and the priority for responding.

With reference back to FIG. 2, the remote monitoring system will send a second alert signal to the second mobile device based on the proximity comparison, where the first alert signal and the second alert signal are different based on the proximity comparison 88. The remote monitoring system will send out notifications to previously notified caregivers and administration staff to inform them that a response to the incident has occurred. The system can further detect if and when a response to the incent has occurred by continuing to monitor the fallen subject, their environment, and caregiver location data. Thus, if the remote monitoring system fails to detect the arrival of a caregiver in a timely fashion the remote monitoring system will send out re-notifications to caregivers and administrative staff as well as notifying other caregivers and staff of the incident based on preconfigured escalation plan. Or for example, if real time location data of the designated first responder starts to track an increasing time of arrival, an escalation plan can be implemented, for example elevating additional caregivers to first responder status. In another example, before any caregivers arrive, if the remote monitoring system detects the patient returning to a safe unfelled position, or if the remote monitoring system detects the arrival of a caregiver not associated with the remote monitoring system (e.g. other medical staff or EMS) the remote monitoring system will de-escalate the response of the designated first responder and update remaining caregivers and administrators accordingly.

Thus in one embodiment, the remote monitoring system only sends targeted alarms based on the proximity comparison of caregivers. The configuration of caregiver's information with the remote monitoring system includes mobile phone communication information and caregivers' capabilities. The remote monitoring system may further leverage preexisting Wi-Fi proximity detection technology, GPS proximity detection technology, Bluetooth proximity detection technology or any proximity detection technology to determine caregivers' proximity to the incident. The remote monitoring system processes caregivers' location information and caregiver's configuration information to determine who should receive targeted alarm notifications. The remote monitoring system continues to monitor the fallen patient after the incident to determine if caregivers have responded and continued monitoring includes renotification of caregivers and reports to administrative staff.

Monitoring device feedback components such as camera and sensor components detect and send biomechanical information to the remote monitoring system. These components can be BLE and Wi-Fi enabled. The remote monitoring system provides “command central” support for various embodiments. This includes the ability to setup a specific configuration needed to carry out user desired embodiments via a system portal. The system can perform the following functions:

The system portal 15 provides a mechanism to configure both on-premises (i.e. in a healthcare facility) and off-premises caregivers' (i.e. patients home) information associated with the monitored patient(s). This includes the monitored individual's home caregivers as well for situations where the monitoring is done at the monitored patients' home. In this situation, the system sends notifications to the closest caregivers in proximity to someone's home. Here, the remote monitoring system would utilize previously existing technology of GPS tracking to track the location of those home health care providers.

The remote monitoring system receives biomechanical information from the monitoring device of a fallen monitored patient (or e.g. a patient identified as a fall-risk).

The remote monitoring system receives biomechanical information from the monitoring device regarding caregiver's response to incident.

The system portal provides a mechanism for a user (such as an administrator, installer, etc.) to obtain up to date incident status information from the remote monitoring system for all incidents. After the incident has been resolved, the system portal will continue to provide an ability to view relevant information related to the incident.

The remote monitoring system receives up to date biomechanical information from the monitoring device for the fallen individual which allows tracking of his/her location after the incident.

The remote monitoring system receives up to date information from caregivers' mobile phones (or other location detection devices such as wireless IR sensors, watches, etc.) for the proximity of the caregivers to the fallen individual.

The remote monitoring system determines which caregiver should receive special notifications specific to the incident based on their proximity to the person in need.

The remote monitoring system sends out notifications to all caregivers configured to receive notifications including special notifications to specific caregivers after the incident.

The remote monitoring system receive biomechanical information from the monitoring device which it uses to recognize caregiver assistance given to the fallen monitored patient.

The remote monitoring system sends renotifications to caregivers including special notifications to specific caregivers if there is no response to incident is detected.

Examples of message priority and types of messages or information provided to caregivers in closest proximity versus remaining caregivers are provided below.

| | | | | | Remote | |
|---|---|---|---|---|---|---|
| | | | | | Monitoring | |
| | Alert | Proximity | | | Clock/Sensor | Caregiver |
| Notification Type | Severity | Category | Timestamp | Location | ID | ID |
| Fall Risk Alert | 01 = 1 | 01 = First | Date & | Organization, | Clock/Sensor | N/A |
| Indication | Yellow | Responder, | Time | Facility, | ID | |
| | Alert- | Closest to | | | | |
| | Predicative | Incident | | | | |
| | Risk Factor | 02 = Second | | | | |
| | 02 = | Responder | | | | |
| | Orange | 03 = Escalation | | | | |
| | Alert- | Indication | | Building, | | |
| | Imminent | 04 = | | Floor, Room | | |
| | Risk | Administrative | | | | |
| | Factors | Notification | | | | |
| | 03 = Red | | | | | |
| | Alert- | | | | | |
| | Post-Fall | | | | | |
| Fall Risk Alert | N/A | N/A | Date & | Organization, | Clock/Sensor | Caregiver |
| Acknowledgement | | | Time | Facility, | ID | ID |
| | | | | Building, | | |
| | | | | Floor, Room | | |
| Fall Risk Alert | N/A | N/A | Date & | Organization, | Clock/Sensor | Caregiver |
| Resolved | | | Time | Facility, | ID | ID |
| | | | | Building, | | |
| | | | | Floor, Room | | |

For example, a caregiver designated as the (01) First Responder may receive information including their First Responder designation, time and location of the incident, and patient specific information such as patient name, weight and a type of fall or fall risk detected. A live video and/or audio feed into the patient's environment may also be available to the (01) First Responder (e.g. actual video or a graphical representation of the patient such as an avatar). Embodiments may include an option for the (01) First Responder to request additional high priority/first responder resources, if for example the (01) First Responder is in a circumstance where they cannot respond quickly or perform the tasks needed to help the patient (e.g. due to (01) First Responder injury, sickness, inability to reach the patient location quickly or other real time circumstances the remote monitoring system may not be aware of). This may be in the form of a simple one-click button on the (01) First Responder's mobile device to avoid delays in the patient response. Other caregivers or administrative staff that are configured to receive alerts may for example receive only a subset or generalized summary of this information, and may further receive less frequent alerts and updates.

Caregiver mobile devices such as mobile phone or other location communication and location detection devices such as wireless IR sensors, smart watches, etc. are communicatively connected to the remote monitoring system. A notification component of the device is used to alert the appropriate caregiver member of the fallen individual. The remote monitoring system is configured to communicate over a multitude of wireless technologies that exist on premises including Wi-Fi to this device. This mobile device also provides the remote monitoring system with up to date on-premises location information leveraging existing Wi-Fi router proximity detection or Bluetooth or future proximity detection technologies. This device also leverages previously existing technology to provide the remote monitoring system with up-to-date GPS location detection technology. The mobile device is also used during the installation of the remote monitoring system clock/sensor, taking advantage of their co-location. Accordingly, a GPS location of the remote monitoring system can be provided via the mobile device's GPS. During the installation process for the remote monitoring system clock/sensor, an installer uses the mobile device to configure the remote monitoring system clock/sensor, during which they are co-located. One of the steps in the installation process is for the mobile device to send its GPS location information to the remote monitoring system to be stored in its database for the remote monitoring system clock/sensor being installed.

The system portal 15 in one embodiment provides setup access, configuration access, information access, administrative access and monitoring access to the remote monitoring system. The system portal provides a mechanism to access and review details of the incident. This component can be used to view all incident status for a given healthcare premises during and after the incident. The portal can associate caregivers (i.e. inside and outside the premises) with monitored patients—for example, home healthcare aides that take care of monitored patients in their homes. Users can enter via the portal information about the premises location of the monitoring devices. The ability to enter and preset location data provides instant location information for the fallen monitored patient in the event of an incident. This information will also be used to track the progress of the fallen patient if he or she moves away from where the incident occurred. The portal further provides a mechanism to associate monitoring devices with monitored patients and characteristics of the patient and/or their premises that may be helpful in a rapid response event.

In one embodiment, the system portal 15 allows entry of detailed capabilities of associated caregivers. This additional information can be used in customized notifications to caregivers when the incident occurs. Thus the system portal can associate administrative personnel with monitored patients in a health care facility. This association can be used to provide an up to date status of a monitored individual incident within the facility. Further, the portal allows for entry of caregiver information including mobile phone information, associates a location detection device with location, caregiver, facility, etc., and leverages pre-existing configuration capabilities associated with health monitoring.

Embodiments of the monitoring devices identify and detect the fallen individual and send notifications to the remote monitoring system. The monitoring devices provide continued monitoring of fallen individuals after the incident to detect the response of the caregivers to the incident along with notifications to the remote monitoring system. The monitoring devices also provide the remote monitoring system with real time on-premises location and orientation information of the fallen individual. The monitoring device's location can be entered when the device is configured via the system portal, and this location is used to determine the location of the fallen individual.

Embodiments of system configuration and incident status reporting will now be described in more detail. Embodiments described herein may require pre-configuration to carry out certain features. The system configuration may be completed via the system portal and will allow the user (such as an Administrator, Installer, etc.) to enter the information prior to executing rapid response incident functionality.

Configuration may include access to status of current and past incidents reported to the remote monitoring system. This aspect of the system can be used by healthcare facilities to improve their operations with respect to fast response for in-home patients as well as patients being monitored in a health care facility. The remote monitoring system would store all current and past incidents.

Configuration may include information needed to associate caregivers (i.e. inside and outside the premises) with monitored patients. Caregivers' identification information as well as the care givers mobile device information would be entered. Specific capabilities of the caregivers can also be listed.

Configuration may include information needed to enter the premises location of the monitoring devices. With regards to this invention, this will provide the location of the fallen monitored patient incident. This will also be used to track the progress of the fallen patient if he or she moves away from where the incident occurred. This location information could also be used to track movement of the fallen individual after the incident has occurred and before the caregivers have responded.

Configuration provides a mechanism to associate monitoring devices with monitored patients. This is done for individuals that are monitored at home or in a facility.

Configuration provides a mechanism to enter detailed capabilities of associated caregivers. This additional information would be used in customized notifications to care givers when the incident occurs. For example, one care giver may be able to move a heavy fallen patient, while another caregiver may be trained to administer critical medication, while another caregiver may be able to provide critical mental health care.

Still further, configuration provides a mechanism to associate administrative personnel with monitored patients in a health care facility and caregiver mobile device information.

In some aspects of the health monitoring system, software executing the instructions provided herein may be stored on a non-transitory computer-readable medium, wherein the software performs some or all of the steps of the embodiments when executed on a processor.

Aspects of the health monitoring system relate to algorithms executed in computer software. Though certain embodiments may be described as written in particular programming languages, or executed on particular operating systems or computing platforms, it is understood that the health monitoring system is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the health monitoring system may be executed on any acceptable computing platform, including but not limited to a server, a cloud instance, a workstation, a thin client, a mobile device, an embedded microcontroller, a television, or any other suitable computing device known in the art.

Parts of the health monitoring system are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of the health monitoring system are described as communicating over a variety of wireless or wired computer networks. For the purposes of embodiments of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth, Bluetooth Low Energy (BLE) or Zigbee communication links, or any other method by which one electronic device is capable of communicating with another. In some embodiments, elements of the networked portion of the health monitoring system may be implemented over a Virtual Private Network (VPN).

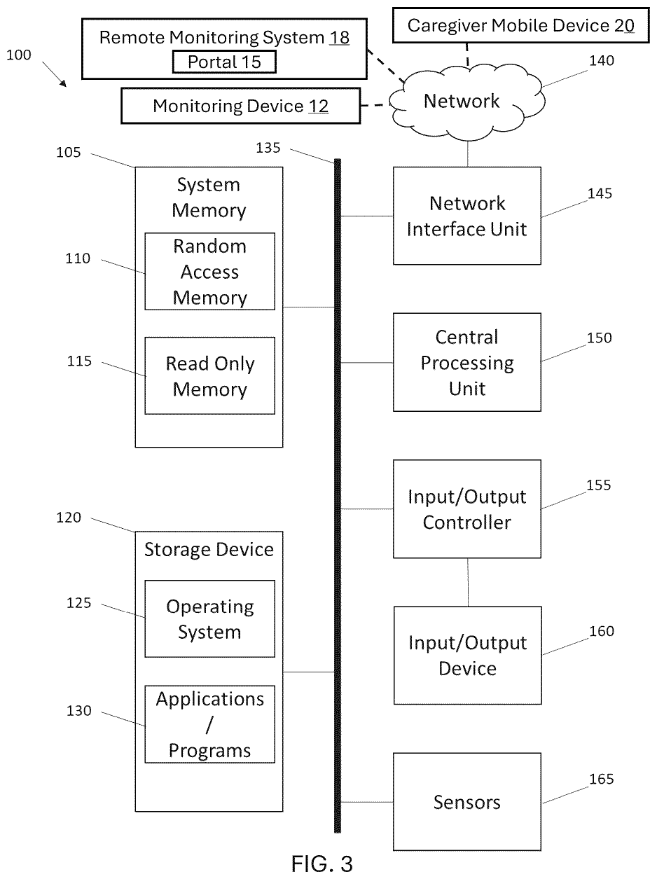

FIG. 3 and the following discussion are intended to provide a brief, general description of a suitable computing environment in which a rapid response system may be implemented according to one embodiment. While the rapid response system is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The rapid response system may also be practiced in distributed computing environments where tasks are performed by remote processing devices that are linked through a communications network. In a distributed computing environment, program modules may be located in both local and remote memory storage devices.

FIG. 3 depicts an illustrative computer architecture for a computer 100 for practicing the various embodiments of the invention or for example operating as the controller 100. The computer architecture shows a conventional personal computer, including a central processing unit 150 (“CPU”), a system memory 105, including a random-access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media, provide non-volatile storage for the computer 100. Although the description of computer-readable media contained herein refers to a storage device, such as flash memory, a hard disk or CD-ROM drive, it should be appreciated by those skilled in the art that computer-readable media can be any available media that can be accessed by the computer 100.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

The monitoring device 12, remote monitoring system 18, system portal 15 and caregiver mobile device 20 of previous embodiments may communicate with one or more controllers such as a computer 100 through a network 140. According to various embodiments of the rapid response system, the computer 100 may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems. Connections between devices and modules can be wired or wireless connections with examples of connection types and modalities explained in further detail below.

The computer 100 may also include an input/output controller 155 for receiving and processing input from a number of input/output devices 160, including a keyboard, a mouse, a touchscreen, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, ethernet, or copper wire or wireless means including, but not limited to, Wi-FI, Bluetooth, Near-Field Communication (NFC), infrared, or other suitable wired or wireless connections.

As mentioned briefly above, a number of program modules and data files may be stored in the storage device 120 and RAM 110 of the computer 100, including an operating system 125 suitable for controlling the operation of a networked computer. The storage device 120 and RAM 110 may also store one or more applications/programs 130. In particular, the storage device 120 and RAM 110 may store an application/program 130 for providing a variety of functionalities to a user.

The computer 100 in some embodiments can include a variety of sensors 165 for monitoring the environment surrounding and the environment internal to the computer 100. These sensors 165 can include physiological sensors, sensors on household appliances and mechanical systems, a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, imaging device, camera or any other suitable sensor.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

1. A system for response to a detected fall or fall risk comprising:
a plurality of monitoring devices including at least a first monitoring device having a first camera and a second monitoring device having a second camera;
a plurality of mobile devices including at least a first mobile device and a second mobile device; and
a controller communicatively coupled to the plurality of monitoring devices and the plurality of mobile devices;
wherein the first monitoring device is configured to send biomechanical information to the controller captured by the first camera;
the controller is configured to detect a fall or a fall risk of a subject based on the biomechanical information received from the first monitoring device; and
wherein the controller is configured to:
send a first alert signal to the first mobile device based on a proximity comparison of first caregiver location data received from the first mobile device, second caregiver location data received from the second mobile device, and preset first location data associated with the first monitoring device, and
send a second alert signal to the second mobile device based on the proximity comparison, wherein the first alert signal and the second alert signal are determined based on the proximity comparison.

2. The system of claim 1, wherein the first alert signal and the second alert signal are different based on the proximity comparison.

3. The system of claim 1, wherein the first alert signal is modified based on a capabilities comparison of a first caregiver profile associated with the first mobile device and a second caregiver profile associated with the second mobile device.

4. The system of claim 1, wherein the second alert signal is modified based on a capabilities comparison of a first caregiver profile associated with the first mobile device and a second caregiver profile associated with the second mobile device.

5. The system of claim 1, wherein the controller is configured to send a third alert signal to a third mobile device based on the proximity comparison further including third caregiver location data received from a third mobile device, wherein the third alert signal is different from the first alert signal and the second alert signal.

6. The system of claim 1, wherein the controller is configured to send an escalation signal to the first and second mobile devices based on reaching a threshold time without a video signal captured by the first camera detecting arrival of a caretaker.

7. The system of claim 6, wherein the controller is configured to send first and second escalation notifications to the first and second mobile devices based on an updated proximity comparison of updated first caregiver location data and updated second caregiver location data.

8. The system of claim 1, wherein controller is configured to detect a de-escalation signal based on a biomechanical information captured by the first camera detecting arrival of a caretaker.

9. The system of claim 8, wherein the controller is configured to send first and second de-escalation notifications to the first and second mobile devices based on an updated proximity comparison of updated first caregiver location data and updated second caregiver location data.

10. The system of claim 1, wherein the controller is configured to detect a de-escalation signal based on a biomechanical information captured by the first camera detecting an unfelled position of the subject.

11. The system of claim 1 wherein the proximity comparison comprises at least one of a distance proximity comparison and a time of arrival proximity comparison.

12. A method for response to a detected fall or fall risk comprising:
detecting a fall or fall risk of a subject based on biomechanical information captured by a first camera of a first monitoring device;
sending a first alert signal to a first mobile device based on a proximity comparison of first caregiver location data received from the first mobile device, second caregiver location data received from a second mobile device, and preset first location data associated with the first monitoring device;
sending a second alert signal to the second mobile device based on the proximity comparison, wherein the first alert signal and the second alert signal are determined based on the proximity comparison.

13. The method of claim 12, wherein the first alert signal and the second alert signal are different based on the proximity comparison.

14. The method of claim 12, wherein the first alert signal is modified based on a capabilities comparison of a first caregiver profile associated with the first mobile device and a second caregiver profile associated with the second mobile device.

15. The method of claim 12, wherein the second alert signal is modified based on a capabilities comparison of a first caregiver profile associated with the first mobile device and a second caregiver profile associated with the second mobile device.

16. The method of claim 12 further comprising:
sending a third alert signal to a third mobile device based on the proximity comparison further including third caregiver location data received from a third mobile device, wherein the third alert signal is different from the first alert signal and the second alert signal.

17. The method of claim 12 further comprising:
sending an escalation signal based on reaching a threshold time without a video signal captured by the first camera detecting arrival of a caretaker.

18. The method of claim 17 further comprising:
sending first and second escalation notifications to the first and second mobile devices based on an updated proximity comparison of updated first caregiver location data and updated second caregiver location data.

19. The method of claim 17 further comprising:
the controller detecting a de-escalation signal based on a biomechanical information captured by the first camera detecting arrival of a caretaker.

20. The method of claim 19 further comprising:
sending first and second de-escalation notifications to the first and second mobile devices based on an updated proximity comparison of updated first caregiver location data and updated second caregiver location data.

21. The method of claim 12 further comprising:
sending a de-escalation signal based on a biomechanical information captured by the first camera being sent to the controller, and which the controller detects an unfelled position of the subject.

22. The method of claim 12, wherein the proximity comparison comprises at least one of a distance proximity comparison and a time of arrival proximity comparison.

23-28. (canceled)
